(19) United States
(12) Patent Application Publication
(10) Pub. No.: US 2015/0209710 A1
(43) Pub. Date: Jul. 30, 2015

(54) AIR QUALITY CONTROLLED AIR FILTERING SYSTEM

(71) Applicant: John Reid, Royal Oak, MI (US)

(72) Inventor: John Reid, Royal Oak, MI (US)

(21) Appl. No.: 14/684,709

(22) Filed: Apr. 13, 2015

Related U.S. Application Data
(62) Division of application No. 14/303,929, filed on Jun. 13, 2014.
(60) Provisional application No. 61/834,980, filed on Jun. 14, 2013.

(51) Int. Cl. B01D 46/44

(52) U.S. Cl. CPC B01D 46/442

(57) ABSTRACT

The present invention provides an air filtering system and method that continuously monitors and samples the air to measure the amount or concentration of suspended particulate matter in an area. Based on the information collected the air filtering system determines the need for and the amount and volume of air filtering that is required. In this way, the air filtering system only operates at the needed capacity to filter the air, and dynamically responds in real time to the fluctuating air contamination levels that occur during various work processes within the space, room or building.

### RELATED APPLICATIONS

This is a divisional application which claims priority to U.S. patent application Ser. No. 14/303,929, filed Jun. 13, 2014, entitled “Air Quality Controlled Air Filtering System” which claims benefit to provisional application No. 61/834,980, filed on Jun. 14, 2013, entitled “Air Quality Controlled Air Filtering System”.

### STATEMENT REGARDING FEDERALLY SPONSORED RESEARCH

NONE

### TECHNICAL FIELD

This invention generally relates to an air filtering system and, more particularly, to an air filtering system that measures air quality in an enclosed space, such as an industrial or manufacturing facility, building, work area, workroom etc. and controls the activity and speed of the filtering unit/s for maximum efficiency.

### BACKGROUND OF THE INVENTION

Air filtering systems are well known throughout several industries where maintaining a clean environment is important. For example, in vehicle manufacturing, welding processes are necessary for welding steel frames for vehicles. Typically, such welding processes are carried out in a work area wherein particulates are generated and infiltrate the air. The air filtering ventilation systems transfer the air through filters that capture the particulates and expel the filtered air back into the work area.

Typical air filtering systems can take many forms. One type is a floor mounted filter unit that sits on the floor of a manufacturing facility in close proximity to the area to be cleaned. These units have a cabinet that houses one or more filters. Air is drawn into the cabinet through a duct, hood, extension arm, intake screen or similar apparatus, drawn through the filters and through the motorized fan or blower wheel and then expelled back into the facility.

Another type of air filtering system is a filter unit that extracts air from a large area or the entire air volume enclosed within a building or structure, such as the factory work floor, which works to clean the entire enclosed air volume rather than smaller local areas. One configuration is to have several ducts that draw in air from various locations around the work area. The air is pulled through filters and then expelled back into the facility. Another configuration is to draw the air directly into the filter unit through an intake screen, and then filter the air, and discharge it though nozzles that direct the air to specifically create air circulation patterns in the enclosed volume or room, usually working in conjunction with one or more filter units.

All of these traditional filtering systems run at maximum capacity when they are operational, or run at reduced speeds or capacities as dictated by the operator, for example when a section of the ductwork system is shut off when filtration and ventilation at certain work stations or processes is not required. The filtering systems operate at an arbitrary rate, regardless of the amount of contaminants in the air. This is very inefficient, using energy needlessly, placing needless wear on the equipment, reducing overall filter life and increasing downtown due to the need for additional filter maintenance.

One type of unit equipped with speed adjustment control for the motors through the use of a variable frequency drive can vary the capacity and speed of the filtration unit, however, it is not based on a measure of particulates in the air. These units are, on either the quantity and volume of connected and active fume sources, the condition and restriction the filters place on the airflow.

The present invention is aimed at solving the problems described above.

### SUMMARY OF THE INVENTION

In general terms, this invention provides an air filtering system that continuously monitors and samples the air to measure the amount or concentration of suspended particulate matter in an area. Based on the information collected the air filtering system determines the need for and the amount and volume of air filtering that is required. In this way, the air filtering system only operates at the needed capacity to filter the air, and dynamically responds in real time to the fluctuating air contamination levels that occur during various work processes within the space, room or building.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is an example of an air filtering unit that could be used with the present invention; and

FIG. 2 is a schematic of the air quality controlled air filtering system of the present invention.

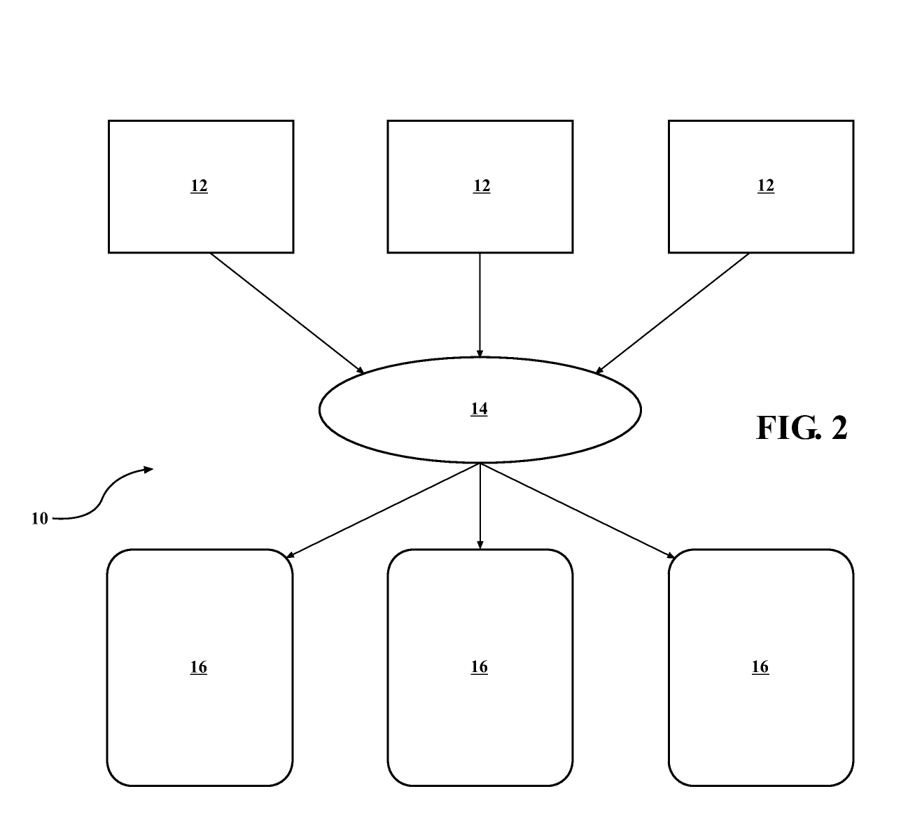

### DETAILED DESCRIPTION OF A PREFERRED EMBODIMENT

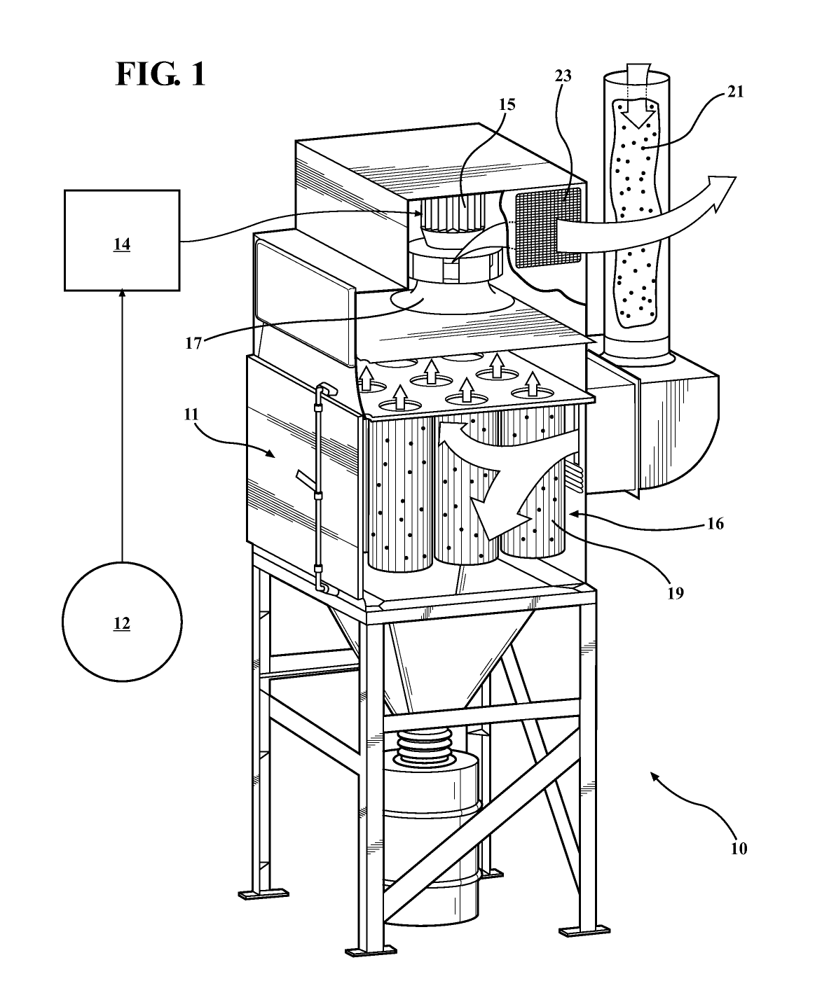

The present invention is shown generally at 10 in FIG. 1. FIG. 1 is a schematic representation of the air filtering system of the present invention.

In the disclosed embodiment at least one air quality sensor 12 is positioned in a work area, such as a welding station, a workroom, an entire building etc. An example of an air quality sensor is a Remote 5014P airborne particulate counter, sold by Lighthouse Worldwide Solutions. It should be appreciated that depending upon the type and size of the work area, more than one air quality sensor may be desired.

The air quality sensor 12 may be of several types for example a particle counter, a dust, particulate or aerosol monitor or impactor probe, etc. There are a number of air quality sensors available on the market and one of ordinary skill in the art would know which would be most effective in a given work area.

The sensor 12 is operatively connected to a master control 14. An example of a master controller is a 6181P or 6181F integrated display computer sold by Rockwell Automation. It should be appreciated by those of ordinary skill in the art that one or more master controls 14 could be used, depending upon the application. The master control 14 receives input from the sensor 12 regarding the quality of the air. The master control 14 is a programmable logic controller or similar digital control component. The master control(s) 14 is operatively connected to one or multiple air filter units 16. With reference to FIG. 1, an example of an air filter unit 16 is illustrated. The air filter unit 16 includes a housing 11, a drive motor 15, a blower fan 17 operatively connected to said drive motor 15 and a filter 19 for filtering impurities from air pulled through said housing 11 by the blower fan 17. As shown in FIG. 1, air is pulled into the intake 21 by the blower fan 17, through the filter 19 and then forced out of the housing 11 at the exit 23. The air filter unit 16 is shown merely as an example unit, it being understood that the present invention will work with any type of air filtering system.

If the air is within a certain predetermined acceptable or clean quality range, the master controller 14 will communicate this information to the air filter unit 16 and the air filter unit will remain off. In the event the air quality has particulates that exceed a predetermined level, i.e. the air quality is at a level that requires it to be filtered, the master controller 14 communicates the level of the air quality or the level of particulates to the air filter unit 16. The communication from the master controller 14 to the air filter unit 16, not only tells the air filter unit 16 to turn on, but also the speed and the duration.

The master controller 14 is programmable to properly receive the information from the sensor and convey correct instructions to the air filter unit 16. In addition, if desired, the master controller 14 can also provide outputs of information. This could be for example in the form of a recorded date and time record or log of the air quality in the work area at any given time and the operation of the air filter unit 16 during those times. More specifically, the data could include the air quality before the air filter unit 16 was energized, the time the air filter unit 16 was operational, the speed at which it operated and the air quality after operation. It should be appreciated by those of ordinary skill in the art, that other data could also be monitored as desired.

The air filter unit of the present invention, in the most desired embodiment, includes a variable frequency drive 18. An example of a variable frequency drive is a Powerflex 525 AC drive sold by Rockwell Automation. This is connected to an AC motor, an example of which is a CEM3769T motor sold by Baldor. The variable frequency drive 18 allows the air filter unit 16 to be operated at various speeds as required by the air quality. If the air quality is only slightly above desired levels, the master controller 14 will communicate to the air filter unit 16 to operate at a low, slow level for a short period of time. If the air quality is at higher undesirable levels, the master controller 14 will communicate with the air filter unit 16 to operate at higher levels for longer periods of time, or at higher levels for shorter periods of time, etc. All the communications are based upon the programming of the programmable logic controller of the master controller 14.

Additional readings continue to be taken by the sensors 12 and the speed and duration of operation of the filtration units are adjusted to bring the air quality back to the target levels. When this is reached, the units (acting on subsequent readings and instructions) would be reduced in speed or turned off, achieving power consumption and filter life savings. Through this method the optimum air quality level can be maintained with the minimum required power and filter consumption.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A method for filtering air, said method including the steps:
providing an air filter unit including a housing, a drive motor, a blower fan;
operatively connecting said drive motor to said blower fan providing a filter for filtering impurities from air pulled through said housing by said blower fan;
providing a master controller operatively connected to said drive motor, controlling the operation of said drive motor by said master controller;
providing an air quality sensor, operatively connecting said air quality sensor to said master controller;
sensing the quality of the air with said air quality sensor sensing, collecting information relating to the quality of the air with said air quality sensor, relaying said collected information to said master controller;
communicating instruction from said master controller to said drive motor;
operating said drive motor based upon said instructions to control said drive motor such that said filter unit filters the air according to the quality of the air to be filtered.

2. The method of filtering air claim 1, further including the step of controlling the speed and duration of operation of said drive motor by said master controller.

3. The method of filtering air of claim 1, further including the step of said master control analyzing said collected information in relation to a predetermined acceptable clean air quality range, said master controller communicating instructions to said drive motor controlling said drive motor between a range from off to full speed.

4. The method of filtering air of claim 3, further including the step of operating said drive motor for a period of time;
determining said period of time by said sensor sensing the air until the air quality is in the acceptable clean range.

5. The method of filtering air of claim 1, programming said master controller to receive collected information from said sensor and convey instructions to said drive motor.

6. The method of filtering air of claim 1, further including the step of collecting operation information regarding the operation of said air filter unit;
providing an output of said operation information.
